(19) United States
(12) Patent Application Publication
(10) Pub. No.: US 2024/0184845 A1
(43) Pub. Date: Jun. 6, 2024

(54) COMPUTER IMPLEMENTED METHOD OF SOLVING A RECONFIGURATION PROBLEM

(71) Applicant: UPSCALE QUANTUM SOLUTIONS INC., Waterloo (CA)

(72) Inventors: Alexandre COOPER-ROY, Waterloo (CA); Amer E. MOUAWAD, Beirut (LB); Remy EL SABEH, Beirut (LB)

(21) Appl. No.: 18/527,872

(22) Filed: Dec. 4, 2023

Related U.S. Application Data
(60) Provisional application No. 63/430,114, filed on Dec. 5, 2022.

(51) Int. Cl. G06F 17/11

(52) U.S. Cl. CPC G06F 17/11

(57) ABSTRACT

A computer-implemented method of solving a reconfiguration problem, the method comprising: solving an all-pairs shortest path (APSP) problem, including computing a distance between each token source location and each token target location; solving an assignment problem on the computed distances, said solving the assignment problem yielding a path system having a set of shortest paths; performing a cycle breaking function on the path system, the cycle-breaking function breaking all cycles in the path system; and ordering order the cycle free path system.

### BACKGROUND

Programmable arrays of optical traps have recently emerged as an effective tool to assemble configurations of particles (e.g., single atoms and molecules) with arbitrary spatial geometries. Supplemented with strong, tunable interactions like Rydberg-Rydberg interactions, these configurations realize large, coherent quantum many-body systems that act as versatile testbeds for quantum science and technology.

An example of such a system is schematically presented in FIG. 1. In practice, the trap array is typically coupled to hardware elements which will be referred to herein as a controller for simplicity. The hardware elements of the controller can be categorized in two sub-groups which may or may not be mutually exclusive depending on the embodiment: a measurement system and an actuator system. The actuator system can perform functions such as initializing the trap array with an initial configuration of particles. In the initial configuration, particles may be randomly interspersed with particle-less traps in the trap array. The measurement system can be used to measure the presence or absence of particles at each trap in the trap array, and therefore to provide information as to what the initial configuration is in a particular instance. Some form or another of a computer can then be used, in association with software functions, to determine a sequence of “moves” or displacement trajectories for one or more of the particles, which is deemed to, upon execution, allow to change the initial configuration to a target configuration. The target configuration can be one where the experiments can be performed. Depending on the embodiment, this “computer” can be part of the controller, be connected to the controller in a wired manner, or be connected to the controller in a wireless manner, either directly, or indirectly (e.g. via a local network or a telecommunications network such as the Internet). Such challenges may be addressed by the engineering of algorithmic technologies used to solve “reconfiguration” problems. Reconfiguration problems are known to be hard combinatorial optimization problems that seek a sequence of control operations to prepare a given configuration of particles from an arbitrary one.

From the point of view of the computer executing the software functions which solve the reconfiguration problem, the nature of the particles can be abstracted and represented by indistinguishable tokens. Similarly, the nature of the particle traps, and the paths along which particles can be displaced from one particle trap to another can be abstracted and represented by a graph having a plurality of locations indistinguishable except for the manner in which they are interconnected to the other locations of the graph. A solution to the reconfiguration problem can thus be provided in the form of an abstract collection of data referred to as a path system, including a set or collection of paths.

The actuator system can further perform functions such as executing the sequence of displacement trajectories, based on the path system, thereby moving individual particles or groups of particles from their initial locations in the traps to locations associated with the target configuration. The measurement system can then also be used to determine whether the overall displacement operation, or individual steps of the operation, is a success or a failure. Indeed, in the case of optical traps and with the technology available at the time of filing this specification, a non-negligible probability of particle loss was present. The probability of particle loss could be associated to any displacement operation on the particles, and could also be a function of time elapsed between the initial configuration and the target configuration, imposing particular challenges on the efficiency of algorithms executed by the computer to determine the sequence of displacement trajectories.

The difficulties associated with providing software technologies which can address reconfiguration problems scale significantly with the amount of possible combinations (e.g., the number of traps and/or of particles). In the absence of atom loss, finding a control protocol that exactly minimizes the total number of displacement operations, without concern for any other performance metrics, can be done in polynomial time using assignment algorithms, such as those based on the Hungarian algorithm, whereas finding a control protocol that minimizes the total number of displaced atoms is an NP-complete problem (even on very simple geometries, such as grids), which can be approximately solved in polynomial time using the Steiner tree 3-approximation algorithm (3-approx). While such algorithmic technologies were satisfactory to a certain degree, there remains room for improvement. In particular, there remained unaddressed technological problems associated with improving success probability and/or improving processing speed, especially when factoring in elements such as probability of loss.

### SUMMARY

It was found that relying on assignment algorithms to solve particle reconfiguration problems suffers from two drawbacks. The first drawback is that the displacement trajectories are sorted and executed in an arbitrary order, without concern for early displacement trajectories obstructing later displacement trajectories. The same atom might be displaced multiple times, further increasing the probability of losing it. The second drawback is that these assignment algorithms do not optimize for the number of displaced atoms. If single atoms are displaced sequentially, then increasing the number of displaced atoms increases the number of transfer operations required to extract and implant the atoms from and into the array of optical traps, and thus increases the probability of losing them. Moreover, the algorithm might choose to displace N atoms once instead of one atom N times, which, although equivalent in terms of the total number of displacement operations, results in greater uncertainty about which atoms will be lost, complicating the problem of efficiently allocating surplus atoms to replace lost ones.

It was found that a first way to improve upon the (baseline) assignment algorithms is to use an ordering subroutine which updates the resulting sequence of displacement trajectories by ordering the sequence of displacement trajectories in a manner for each atom to be displaced at most once, i.e., which avoids situations where one particle obstructs the displacement trajectory of another particle.

It was found that a second way to improve upon the baseline assignment algorithm is to use a rerouting subroutine to reroute the displacement trajectory associated with each atom to reduce the number of displaced atoms

It was found that in some embodiments, combining both improvements could lead to even better results.

Indeed, as shown in FIG. 2, a reconfiguration problem can be defined here as a graph represented by circles interconnected to one another by lines. An initial configuration is represented by a configuration of black dots representing tokens (in this example as an abstraction of particles), in a subset of the circles (in this example representing an abstraction of particle traps). The target configuration is represented by green circles amongst the overall group of circles. The atom reconfiguration problem can consist here of finding a sequence of displacement trajectories to transform the initial configuration (which can be an arbitrary distribution of black dots amongst the circles). An assignment algorithm can be used to find the set of displacement trajectories that minimizes the total distance traveled by all atoms, or equivalently the total number of displacement operations. An ordering subroutine can find a sequence of displacement trajectories that prevents an atom from obstructing the path of another atom, here choosing to execute the move associated with P_2 before executing the move associated with P_3. A rerouting subroutine can seek to update each displacement trajectory to reduce the number of atoms displaced without increasing the total displacement distance, here choosing the path P_1′ over the path P_1.

Both subroutines might thus modify the sequence of displacement trajectories, albeit without ever increasing the total number of displacement operations. Hence, besides possibly achieving a reduction in the number of transfer operations, an embodiment of the algorithm can exactly minimize both the number of displacement operations and the number of transfer operations per displaced atom. The resulting reduction in the total number of control operations translates into such an algorithm outperforming both a baseline assignment algorithm and the 3-approx algorithm at solving atom reconfiguration problems in both the presence and in the absence of loss.

In accordance with one aspect, there is provided a computer-implemented method of solving a reconfiguration problem, the method comprising: providing, in a non-transitory memory of the computer, a definition of the reconfiguration problem, the definition including an initial configuration of token source locations on a graph and a target configuration of token target locations on the graph; and a processor of the computer, based on instructions stored in the non-transitory memory: solving an all-pairs shortest path (APSP) problem on the definition of the reconfiguration problem, said solving the APSP problem including computing a distance between each token source location and each token target location; solving an assignment problem on the computed distances, said solving the assignment problem yielding a path system having a set of shortest paths; performing a cycle breaking function on the path system, the cycle-breaking function breaking all cycles in the path system; and ordering order the cycle free path system.

In accordance with another aspect, there is provided a computer-implemented method of solving a reconfiguration problem, the method comprising: providing, in a non-transitory memory of the computer, a definition of the reconfiguration problem, the definition including an initial configuration of token source locations on a graph and a target configuration of token target locations on the graph; and a processor of the computer, based on instructions stored in the non-transitory memory: solving an all-pairs shortest path (APSP) problem on the definition of the reconfiguration problem, said solving the APSP problem including computing a distance between each token source location and each token target location; solving an assignment problem on the computed distances, said solving the assignment problem yielding a path system having a set of shortest paths; and performing a rerouting function, the rerouting function reducing a number of token displacements to reach the target configuration without increasing a total displacement distance.

Many further features and combinations thereof concerning the present improvements will appear to those skilled in the art following a reading of the instant disclosure.

### DESCRIPTION OF THE FIGURES

In the figures,

FIG. 1 is a view of an example of a system for reconfiguring particles in a trap array;

FIG. 2 is a schematic of a definition of a reconfiguration problem and of potential paths associated to a solution;

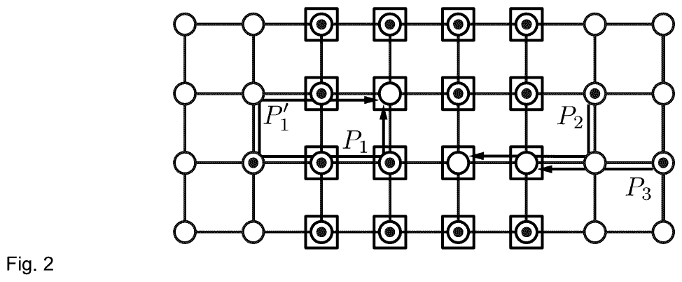

FIG. 3 schematically presents examples of atom reconfiguration problems on graphs;

FIG. 4 is a schematic example of a path system defined on a weighted graph that induces a cycle that cannot be broken by computing a minimum spanning tree (MST) without increasing the total weight of the path system; and

FIG. 5 is a schematic representation of a computer.

### DETAILED DESCRIPTION

### Atom Reconfiguration Problems

Particle reconfiguration problems, such as atom reconfiguration problems, may seek a control protocol [symbol] : [symbol] ₀ [symbol] [symbol] , to transform an arbitrary initial configuration of Nₐ⁰ atoms, [symbol] ₀, into a given target configuration of Nₐ^{T} atoms, [symbol] _{T}. The configuration of atoms is contained in an array of optical traps, [symbol] (V), defined by its spatial arrangement or geometry, V={\vec{x}ⱼ|\vec{x}ⱼ=(xⱼ_{ₓ}, yⱼ_{_{y}})∈ [symbol] ²}, which we choose to be a square lattice of Nₜ=Nₜ^{x}×Nₜ^{y} traps in the plane (a grid) with \vec{x}ⱼ=(xⱼ_{ₓ}, yⱼ_{_{y}})∈ [symbol] ², where xⱼ_{ₓ}=x₀+jₓδx, yⱼ_{_{y}}=y₀+j_{y}δy, jμ∈ [symbol] ([1, Nₜ^{μ}]) for μ∈{x, y}, (x₀, y₀) is the origin of the array, and δx, δy are the lattice spacing constants.

In an example embodiment associated to reconfiguring atoms in an array of optical traps, the control protocol can be composed of a sequence of extraction-displacement-implantation (EDI) sequences that extract, displace, and implant a single atom or multiple atoms simultaneously from one static trap to another using a secondary array of dynamic traps. These EDI sequences are composed of elementary control operations that include elementary transfer operations, T_{α}^{±}, which extract (implant) an atom from (into) a static trap into (from) a dynamic trap, and elementary displacement operations, Tᵥ_{_{μ}}^{±}, which displace a dynamic trap containing an atom from one static trap to another by an elementary displacement step δx or δy. These elementary control operations are supplemented by no-op operations, T_{α,v}⁰, to account for the probability of losing atoms in idle traps while control operations are performed on other traps.

In an operational setting, the initial configuration of atoms is obtained by randomly loading a single atom into each trap of the trap array with a probability given by the loading efficiency ε. Given the initial and target configurations of atoms, the reconfiguration problem is then solved, the control protocol is executed, and a measurement is performed to check whether the updated configuration of atoms contains the target configuration or not. In the presence of loss, the atom reconfiguration problem might have to be solved multiple times through multiple reconfiguration cycles until the target configuration is reached (success) or is no longer reachable (failure). The same algorithm is used independently of the initial configuration, that is, we do not consider adaptive algorithms that are updated based on the measured configuration, nor do we consider protocols that rely on mid-cycle measurements.

More generally, atom reconfiguration problems can be viewed as reconfiguration problems on graphs. A configuration of indistinguishable atoms trapped in an array of optical traps is represented as a collection of tokens placed on a subset of the vertices of a graph, G=(V, E), where V(G) and E(G) are the vertex set and edge set of G, respectively, with |V(G)|=n and |E(G)|=m. We assume that each graph is finite, simple, connected, undirected, and edge-weighted. We use w: E(G)→ [symbol] ⁺ to denote the edge-weight function and we assume that w is positive, i.e., w(e)>0 for all e={u, v}∈E(G).

Although the concepts presented herein are generally valid for arbitrary (edge-weighted) graphs, an example embodiment focussed on (unweighted) grid graphs is presented in greater detail. Specifically, the (p×q)-grid graph, which is a graph of pq vertices with vertex set {(x, y)|x∈{0,1, . . . , p−1}, y∈{0,1, . . . , q−1}} for p, q∈ [symbol] ⁺. We denote the width p of a grid graph G by W_{G}, and its height q by H_{G} (we drop the subscript G when clear from context). Two vertices v=(x, y) and v′=(x′, y′) are adjacent, and thus connected by an edge, if and only if |x−x′|+|y−y′|≤1. Note that m= [symbol] (n) whenever G is a planar graph, as is the case for grid graphs.

In addition to the graph G, the atom reconfiguration problem includes a definition of the initial (source) and desired (target) configurations of atoms. The traps containing the atoms in the source and target configurations are identified as subsets of vertices, S⊆V(G) and T⊆V(G), respectively, such that |S|≥|T| (note that S and T need not be disjoint). We assume that each vertex in S is occupied by a token and the problem is to move the tokens on S*⊆S such that all vertices of T eventually contain tokens, where |T\S|≤|S\T|≤|S*|≤|T|≤|S|.

Here, a move of token t from vertex u to vertex v, which is equivalent to a sequence of elementary displacement operations, is allowed or unobstructed whenever t is on u and there exists a path P (defined below) from u to v in G that is free of tokens (except for t), otherwise, we say that the move is obstructed and call any token t′≠t on P an obstructing token. If we attempt to move a token along a path that is not free of tokens, then we say that this move causes a collision; because a collision induces the loss of the colliding atoms, moves that cause collisions are replaced by sequences of moves that do not cause collisions. Indeed, if the move of token t from u to v is obstructed, then, assuming v is free of tokens, we can always reduce this move to a sequence of unobstructed moves by replacing the move by a sequence of moves involving the obstructing tokens, i.e., solving the obstruction problem. A solution to an atom reconfiguration problem is thus a sequence of unobstructed moves, each of which displaces a token from a vertex marked by a token to a vertex not marked by a token along a path that is free of obstructing tokens.

Our reconfiguration algorithms proceed by constructing a valid path system, which can be understood at a high level as a collection of displacement trajectories, and, after potentially updating the path system, finding the (ordered) sequence of unobstructed moves to execute along every path in the path system. We define a path in a graph G as a walk whose sequence of vertices comprises distinct vertices. We define a walk (of length [symbol] ) in G as a sequence of vertices in V(G), (v₀, . . . , [symbol] ), such that {v₁, vᵢ₊₁}∈E(G) for all i∈{0, . . . , [symbol] −1}, where {v₁, v₂, . . . [symbol] } are the internal vertices of the path. We define a cycle in G as a walk of length [symbol] ≥3 that starts and ends on the same vertex, v₀= [symbol] , and whose internal vertices form a path. The weight of a path is given by the distance between its first and last vertex, d_{G}(v₀, [symbol] ), where the distance between u and v in G is the weight of a shortest path between u and v, computed as the sum of the weights of the edges connecting the vertices of a shortest path P, w(P)=Σ_{e∈P} w(e). When the graph is unweighted, or each of its edges has a weight of one, in which case the graph is said to be uniformly-weighted, then the distance between u and v corresponds to the minimum number of edges required to get from u to v in G.

A path system P in G is a collection of paths, [symbol] ={P₁, P₂, . . . , Pₖ}, in which each path Pᵢ∈ [symbol] for i∈ [symbol] ⁺([1, k]) is a path from vₛ_{ᵢ} (source vertex) to vₜ_{ᵢ} (target vertex), which we denote by {vₛ_{ᵢ}, v₁, v₂, . . . , vₜ_{ᵢ}} (single-vertex paths with vₛ_{ᵢ}=vₜ_{ᵢ} are also allowed). We define a doubly-labeled vertex as a vertex that is both a source vertex and a target vertex, whether within the same path or in two different paths. The weight of a path system is given by the sum of the weights of its paths, w( [symbol] )= [symbol] w(P). Each source vertex vₛ_{ᵢ}∈V(Pᵢ) associated with a path Pᵢ∈ [symbol] contains a token, i.e., vₛ_{ᵢ}∈S; the other vertices in Pᵢ may or may not contain tokens. A token is said to be isolated in a path system [symbol] whenever there exists a single-vertex path P={v}∈ [symbol] such that the token t is on the vertex v and no other path in [symbol] contains vertex v.

We say that a move associated with path Pᵢ∈ [symbol] is executable whenever Pᵢ is not a single-vertex path and the target vertex vₜ_{ᵢ} does not contain a token; an unobstructed move is always executable, whereas an obstructed move can always be reduced to a sequence of unobstructed moves, assuming vₜ_{ᵢ} contains no token. A path system [symbol] is said to be valid (for T) or T-valid whenever there exists some ordering of the moves that makes all the paths executable, and executing all the moves associated with [symbol] results in each vertex in T having a token on it. Clearly, in a valid path system, all source vertices are distinct and all target vertices are distinct, although some source vertices can be the same as some target vertices. We note that for any valid path system, we can always find an ordering in which to execute the moves, i.e., we can always find an executable move, unless the problem is already solved with all vertices in T occupied by tokens. We also note that, whenever we have a token on some target or internal vertex, then there must exist a path for which this token is on the source vertex.

An assignment algorithm can be used to solve an assignment problem to compute a valid path system that minimizes its weight, i.e., in which each path is one of the many possible shortest paths between its source vertex and its target vertex, chosen arbitrarily among the set of all possible shortest paths, and then solves the obstruction problem to find a sequence of unobstructed moves on each path.

### Assignment Algorithm

One approach to solve atom reconfiguration problems is to map them onto assignment problems, which can be solved in polynomial time using an assignment function, such as those based on the Hungarian algorithm. These assignment subroutines compute a (valid) distance-minimizing path system, which is a valid path system, [symbol] , whose weight w( [symbol] ) is minimized, i.e., the resulting control protocol exactly minimizes the total number of displacement operations performed on all atoms. In this specification, the expression “assignment subroutines” can be used to refer to algorithms that solve assignment problems and “assignment algorithms” as reconfiguration functions that compute a valid control protocol.

In accordance with one example, Alg. 1, presented below, can be used to solve reconfiguration problems in five steps, two of which are optional.

```
Algorithm 1. Baseline reconfiguration algorithm.
Require: A static trap array A, represented as a positive
  edge-weighted graph G = (V, E) with Σ_{eϵE(G)} w(e) = O(n^{c}) for
  some positive integer c; an initial configuration of atoms C₀,
  represented as a set of source vertices S ⊆ V (G); and a target
  configuration of atoms C_{T}, represented as a set of target vertices
  T ⊆ V (G).
1. Compute the distance and a shortest path between all pairs of
  vertices of S and T by solving the APSP problem [O(n³) and
  O(n²) on uniformly weighted grid graphs].
2. Compute a distance-minimizing path system, matching every
  vertex in T to a distinct vertex in S and forming a shortest path
  between them by solving the assignment problem [O(n³)].
3. (optional) Using the isolation subroutine, modify the path system
  to (locally) isolate tokens that do not need to be displaced
  [O(n⁵)].
4. Using the obstruction solver subroutine, find a sequence of
  unobstructed moves [O(n²)].
5. (optional) Using the batching subroutine, batch moves to perform
  control operations on multiple atoms in parallel [O(n³)].
```

In the first and second steps, the assignment subroutine computes a valid distance-minimizing path system by solving the all-pairs shortest path (APSP) problem, followed by the assignment problem. In the third (optional) step, the isolation subroutine isolates a maximal subset of tokens found on doubly-labeled vertices; we find a maximal subset (as large as can be found) without guarantee that it is a maximum subset (as large as can be), because finding a maximum subset is equivalent to the NP-complete problem of minimizing the number of tokens that move (which remains NP-complete even on grids). In the fourth step, the baseline obstruction solver computes the sequence of unobstructed moves associated with the path system. In the fifth (optional) step, the batching subroutine combines some of the moves to simultaneously displace multiple atoms in parallel. Examples of such subroutines will now be described in more detail.

### Assignment Subroutine

The assignment subroutine first solves the all-pairs shortest path (APSP) problem in order to compute the shortest pairwise distances between occupied traps in the initial configuration (represented as the set of source vertices S) and occupied traps in the target configuration (represented as the set of target vertices T). More generally, the algorithm consists of computing shortest paths between every vertex in S and every vertex in T. On uniformly-weighted grids, the APSP problem can be solved in time quadratic in the number of vertices ( [symbol] (n²)), as the shortest distance between any two traps in the grid is equal to the Manhattan distance between them (we arbitrarily select the shortest path that consists of at most two straight lines). In the general edge-weighted case, this problem can be solved in [symbol] (n³) time using the Floyd-Warshall algorithm. Alternatively, running Dijkstra's algorithm (from each source vertex), an algorithm that is more easily amenable to parallel implementation, e.g., on a graphics processin unit (GPU), could replace the Floyd-Warshall algorithm to find shortest paths between pairs of vertices in positive edge-weighted graphs.

The assignment subroutine then solves the assignment problem to find one of possibly many sets of pairs of source and target traps that exactly minimize the total distance traveled by all atoms, and thus exactly minimize the total number of displacement operations. The problem of computing a distance-minimizing path system can be reduced to solving an assignment problem using the assignment subroutine. The assignment problem consists of finding a bijection f: A→B that minimizes the total cost Σ_{a∈A} C(a, f (a)), where A and B are two sets of equal cardinality and C: A×B→ [symbol] is a positive cost function. In the absence of a surplus of atoms, i.e., when |S|=|T|, we set A=S, B=T, and for any pair a∈A, b∈B, we choose the cost function C(a, b) to be the distance between vertex a and vertex b). This assignment problem has a polynomial-time solution; the first documented solution, referred to as the Hungarian algorithm, has an asymptotic running time of [symbol] (|A|⁴) that was later improved to [symbol] (|A|³). Clearly, the matching obtained from running the Hungarian algorithm minimizes the total displacement distance.

One example implementation of the assignment subroutine uses the Floyd-Warshall algorithm, modified to store one of the shortest paths between every pair of source and target vertices, to solve the APSP problem, and the Hungarian algorithm to find one of the many possible assignments of source and target traps that minimize the total displacement distance.

### Obstruction Solver

The baseline obstruction solver seeks a sequence of moves associated with a valid path system. Processing every path in the path system in an arbitrary order, the subroutine attempts to move each token from its source vertex to its target vertex. If an obstructing token is present on the path, the subroutine switches the target of the token that it is attempting to move with the target of the obstructing token, updates the path system with the previously-computed shortest paths between the newly updated pairs of source and target vertices, and then attempts to move the obstructing token. The recursive procedure terminates when all vertices in T are occupied.

Formally, consider that the token tᵢ is on the source vertex vₛ_{ᵢ} of a path Pᵢ∈ [symbol] aiming towards its target vertex vₜ_{ᵢ}. If the move associated with Pᵢ is not obstructed, i.e., there is no other token on the path between vₛ_{ᵢ} and vₜ_{ᵢ}, then tᵢ is moved to vₜ_{ᵢ}. Otherwise, there is some obstructing token, say tⱼ, on the path Pᵢ. The baseline obstruction solver finds the target vertex vₜ_{ⱼ} associated with token tⱼ and then switches the target of tᵢ with that of tⱼ. The solver updates the path system by choosing the shortest path (previously computed during the APSP subroutine) for the updated pairings of source and target vertices, and recursively attempts to move the obstructing token. Because it started with a valid path system, the solver is guaranteed to return a valid sequence of unobstructed moves in polynomial time ( [symbol] (n²) time in the worst case).

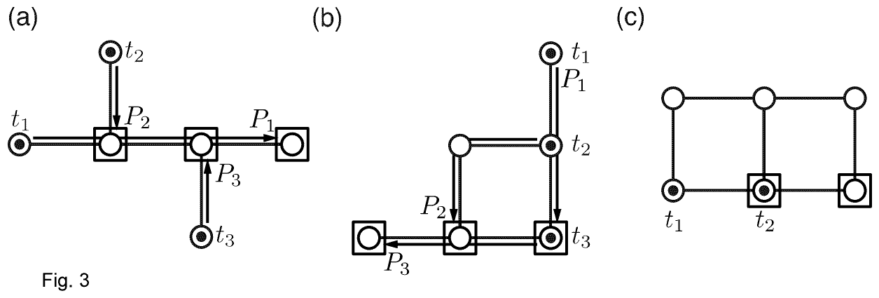

In the absence of loss, the performance of the baseline obstruction solver depends on the ordering of the paths on which moves are executed. Indeed, the ordering affects the number of displaced atoms, as well as the total number of transfer operations. For example, FIG. 3a shows an instance in which the execution of the ordering (P₁, P₂, P₃) displaces every token once for a total of three moves, which is optimal, whereas the execution of the ordering (P₂, P₃, P₁) requires five moves (given that the tokens are moved sequentially, one after the other), with tokens t₂ and t₃ being displaced twice. This is an example problem for which ordering the paths of a path system reduces the number of transfer operations. Executing the move associated with either P₂ or P₃ (or both) before the move associated with P₁ would force t₂ or t₃ (or both) to move twice.

To avoid an unnecessary increase in the number of control operations resulting from an arbitrary ordering of the paths in the path system, the ordering subroutine presented in further detail below can be used to compute a path system that admits an ordering of its paths, so that executing the moves on the ordered path system guarantees that each token is displaced at most once.

The ordering of the paths in the execution of the baseline obstruction solver also affects the number of atoms that are displaced. For example, FIG. 3b shows an instance in which three atoms are displaced for one ordering (P₃, P₂, P₁), whereas two atoms are displaced for another ordering (P₂, P₁, P₃). This is an example problem for which a token (here, t₃) can be isolated without increasing the weight of the path system. Indeed, in the latter ordering, P₂ is not obstructed, so it can be directly executed. Then, because P₁ is obstructed by token t₃, the target of t₁ becomes vt, and the target of t₃ becomes vₜ_{₁}=vₛ_{₃}. The baseline obstruction solver first attempts to move t₃, and, because it already occupies its target, there is nothing to be done. The solver then attempts to move t₁ to vₜ_{₃}. If the shortest path between vₛ_{₁} and vₜ_{₃} goes through P₂, then, because a move on this path is obstructed by t₂, the solver first moves t₂ to vₜ_{₃} and then t₁ to vₜ_{₂}; two tokens have thus been displaced instead of three. Because token t₃ can be discarded from the path system, we say that token t₃ can be isolated; the isolation subroutine seeks to find the tokens that can be isolated and removes them from the path system to reduce unnecessary displacement operations. FIG. 3c presents an example problem for which the displacement distance and the number of displaced tokens cannot be simultaneously minimized, two tokens need to move to minimize the displacement distance whereas one token needs to move if minimizing displacements is not imposed.

### Isolation Subroutine

A potential issue with the assignment algorithm is that it might label a vertex as both a source and a target vertex, either labeling a target vertex as its own source or labeling a vertex as the target of one path and the source of another. Such double labeling might result in unnecessary transfer operations, possibly displacing an atom that could have remained otherwise idle. To eliminate the issue associated with double labeling, we implement an isolation subroutine, which we run before computing the moves associated with the path system, to remove doubly-labeled vertices whenever possible. The removal of a doubly-labeled vertex is possible whenever the recomputed path system obtained after excluding the vertex and its incident edges from the graph and updating S and T accordingly remains valid and has a total weight that is less than or equal to the total weight of the original path system. The isolation subroutine guarantees that every token in the resulting path system has to be displaced at least once. It also guarantees that the assignment algorithm does not serendipitously displace fewer tokens; however, because implementing the subroutine is computationally costly and these serendipitous instances are rare, it may be preferred to ignore this subroutine in an operational setting.

### Batching Subroutine

Because assignment algorithms do not address the number of transfer operations, the resulting control protocols might perform as many extraction and implantation operations as displacement operations, i.e., an EDI sequence for each elementary displacement operation. To reduce the number of transfer operations, we implement a batching subroutine that seeks to simultaneously displace multiple atoms located on the same column of the grid graph within a single EDI sequence. The running time of the batching subroutine is no more than [symbol] (n³).

Although the resulting performance of the assignment algorithm can improved over an assignment algorithm that does not rely on the isolation and/or batching subroutines, a more palpable gain in operational performance may be achieved by further implementing a rerouting subroutine and/or an ordering subroutine.

Accordingly, to improve on the performance of assignment algorithms, we propose the assignment-rerouting (ar) algorithm, which can supplement the assignment algorithms with a rerouting subroutine, the assignment-ordering (ao) algorithm, which can supplement the assignment algorithm with an ordering subroutine, or an assignment-rerouting-ordering (aro) algorithm which can supplement the assignment algorithm with both the rerouting subroutine and the ordering subroutine. Such improvements may lead to fewer transfer operations than the assignment algorithm while still minimizing the total number of displacement operations, thereby strictly improving overall performance in the absence and in the presence of loss.

### Ordering Subroutine

The ordering subroutine constructs an ordered path system that admits a (partial) ordering of its paths, so that the moves associated with each path are unobstructed, i.e., atoms displaced in preceding moves do not obstruct the displacement of atoms in succeeding moves and atoms obstructing certain paths are displaced before the atoms on the paths that they obstruct. This ordering of moves effectively guarantees that each displaced atom undergoes exactly one EDI sequence, thereby restricting the number of transfer operations per displaced atom to its strict minimum of two (one extraction operation and one implantation operation per EDI sequence).

The existence of a polynomial-time procedure to transform any path system into a (valid) ordered path system, in which the paths are ordered such that executing the moves associated with each path displace every atom at most once, is guaranteed by Theorem 1: A path system [symbol] in a positive edge-weighted graph G can always be transformed in polynomial time into a cycle-free path system [symbol] such that w( [symbol] )≤w( [symbol] ), where a cycle-free path system is a path system that includes no cycles, i.e., it induces a cycle-free graph, or a forest. Moreover, the dependency graph associated with the path system [symbol] is a directed acyclic graph (DAG), which admits a partial ordering of its vertices, implying a partial ordering of the corresponding moves.

In simple terms, Theorem 1 states that a path system can always be transformed (in polynomial time) into an ordered path system that admits an ordering of its paths resulting in no obstructions; executing the moves associated with each path is then guaranteed not to cause any collisions. The ordering is obtained by finding the partial ordering of the vertices of the dependency graph, which is a graph where each path is represented by a vertex, and where each dependency of a path Pᵢ on a path PÅ is represented by a directed edge from the vertex representing path Pⱼ to the vertex representing path Pᵢ; Pᵢ is said to depend on Pⱼ if vₛ_{ⱼ} is an internal vertex in Pᵢ, or if vₜ_{ᵢ} is an internal vertex in Pⱼ. This theorem is valid for any arbitrary path system defined over any arbitrary (edge-weighted) graph.

Theorem 1 applies to general (positive) edge-weighted graphs, even when the path system is not distance-minimizing, e.g., is obtained from implementing the distance-increasing rerouting subroutine.

In accordance with a first example, ordering can be performed by a process such as: considering a graph G and a path system P={P1, . . . , Pk} defined on the graph G, with G[P] being the graph G induced on P, performing a first loop consisting of, while the graph G[P] has a cycle C, perform a second loop including going over the edges eₙ of the cycle C one by one and i) construct the graph G′=G−e (delete e from the graph), ii) compute a new path system P′ in the graph G′ (via assignment), iii) if the new path system P′ is valid and distance minimizing then break from loop 2, else continue loop 2 for other edges eₙ of the cycle C.

In accordance with another example, ordering can be performed using a process including a merging step, an unwrapping step, and a cycle-breaking step in accordance with Algorithm 3 below.

```
Algorithm 3. Ordering subroutine.
Require: A valid path system [symbol] , defined on a positive edge-
  weighted graph G with Σ_{eϵE(G)} w(e) = O(n^{c}) for some positive
  integer c.
1. Merge path system [O(n^{c+4}m²) and O(n⁷) on uniformly weighted
  grid graphs].
2. Unwrap path system [O(n²m) and O(n³) on uniformly weighted
  grid graphs].
3. Detect and break cycles in path system [O(n^{c+6}m) and O(n⁸) on
  uniformly weighted grid graphs].
4. Order path system [O(n³)].
```

Algorithm 3 will now be presented in greater detail. The proof of Theorem 1 can, for instance, directly result from the existence of such a process, which efficiently constructs a cycle-free path system and finds the ordering of the paths within it.

First, the merging step converts a path system into a (non-unique) merged path system (MPS). A merged path system is a path system such that no two paths intersect more than once, with the intersecting sections of the two paths possibly involving more than one vertex (all vertices in the intersection being consecutive). The merging operation does not increase the total path system weight, but it can decrease it; if the path system comes from the Hungarian algorithm, then the total weight of the path system is already minimized. A valid merged path system can be computed in time [symbol] (n^{c+4}m²) for a graph G where |V (G)|=n, |E(G)|=m, and Σ_{e∈E(G)} w(e)= [symbol] (n^{c}) for some positive integer c).

Second, the unwrapping step converts an MPS into an unwrapped path system (UPS) by reconstructing tangled paths. An unwrapped path system is a MPS such that no two paths within it are tangled. Two paths are tangled if Pᵢ wraps or is wrapped by Pⱼ, where a path Pᵢ is said to be wrapped in another path Pⱼ if it is entirely contained in it; if Pᵢ is wrapped by Pⱼ, then Pⱼ wraps Pᵢ. Unwrapping the paths that a path Pⱼ wraps is performed by sorting their respective source traps and target traps separately based on their order of occurrence within Pⱼ, and assigning every source trap to the target trap of the same order. A valid UPS can be obtained from a valid MPS in time [symbol] (n²m).

Third, the cycle-breaking step converts an UPS into a cycle-free path system (CPS). The cycle-breaking step modifies the path system such that the graph induced on the modified path system is a cycle-free graph (a forest). Even though a graph can have exponentially many cycles, we prove that the cycle-breaking step can be executed in polynomial time, i.e., a valid CPS can be obtained from a valid UPS in time [symbol] (n^{c+6}m). This result relies on the existence of “special cycles” in a graph with cycles, which can be found. Once a special cycle has been found, the set of paths that induce it can be found and updated to break the special cycle using a polynomial-time algorithm.

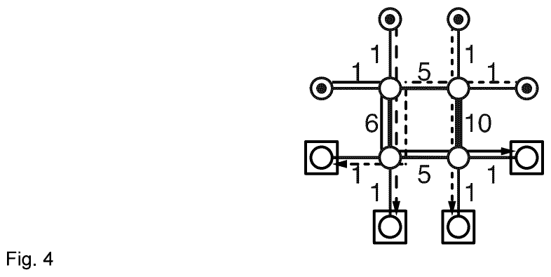

The reason for using the (time-consuming) cycle-breaking procedure to break cycles instead of, e.g., computing minimum spanning trees (MSTs), is that computing an MST to break cycles might in fact increase the total weight of the path system. Indeed, an example on a weighted graph is presented in FIG. 4. In this example of a path system defined on a weighted graph that induces a cycle that cannot be broken by computing a minimum spanning tree (MST) without increasing the total weight of the path system. The initial path system has a total weight equal to 46. The MST of the graph induced on the path system includes all the edges of the graph except for the edge of weight 10. The path system generated by computing all-pairs shortest path on the MST and then computing a source-target matching has a total total weight of 52, irrespective of the specific choice of the matching (among 4!=24 possibilities), as the edges of weight 5 will each be in two paths and the edge of weight 6 will be in 4 paths. A similar example can be constructed for the case of uniformly-weighted graphs, where deleting some edge might increase the weight of the path system

However, we note that our current implementation is mostly following the proof of existence of cycle-free path systems and more efficient implementations (O(n⁴)) are possible. For instance, a different algorithm could iterate over edges of cycles formed by the paths in the path system and attempt to delete them one by one; the deletion of an edge is made permanent whenever we can still find a valid path system of the appropriate weight in the graph minus the edge. The procedure then repeats on the new graph, i.e, the graph minus the edge, until we obtain a cycle-free path system. Proving the correctness of such an algorithm requires proving Theorem 1 and it is therefore important to note that our presentation is oriented towards simplifying the proofs of correctness rather than optimizing the worst-case asymptotic running time of the aro algorithm.

Fourth, the ordering step constructs an ordered path system (OPS) by ordering the moves associated with a CPS, e.g., by constructing the DAG associated with the path system. This step can be performed in time O(n³). The moves associated with the OPS can be computed using the baseline obstruction solver.

### Rerouting Subroutine

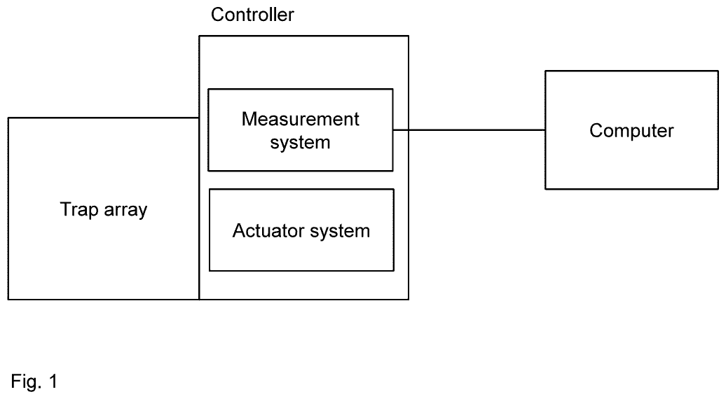

The assignment algorithm returns a path system that minimizes the total number of displacement operations, without concern for the total number of displaced atoms nor the total number of transfer operations. Because the problem of minimizing the number of transfer operations is an NP-complete problem (even on grids), and finding a control protocol that simultaneously minimizes both displacement and transfer operations is impossible for some instances (FIG. 1c), we must resort to using heuristics that seek to reduce the number of atoms that are displaced.

To reduce the number of displaced atoms while preserving the number of displacement operations, we rely on the distance-preserving rerouting subroutine, which attempts to substitute each path in the path system with another path of the same weight that contains fewer vertices occupied by atoms. The intent behind the usage of the rerouting subroutine is to attempt to increase the number of isolated tokens, i.e., tokens that do not have to move. We refer to rerouting a path as updating its sequence of internal vertices while preserving its source and target vertices. This version of rerouting was designed specifically for uniformly-weighted grid graphs (but can easily be generalized).

The subroutine proceeds by looping over every path in the path system, and, for every path, attempting to reroute it, while fixing the rest of the path system, in a way that maximizes token isolation while preserving the weight of the path. If the original path is a straight line, then there is nothing to do, as the path cannot be rerouted without increasing its weight. Otherwise, suppose that the source vertex vₛ of the path is (x₁, y₁) and the target vertex vₜ of the same path is (x₂, y₂), and that, without loss of generality, x₁<x₂ and y₁<y₂. Given W=|x₁−x₂| and H=|y₁−y₂|, there are a total of (W+H)!/H!W! shortest paths between vertex (x₁, y₁) and (x₂, y₂). Using a brute-force approach for every path is inefficient, as the number of rerouted paths to consider for every path is exponential in the Manhattan distance between the source vertex and the target vertex of the path. To avoid an exhaustive search and speed up computation, we exploit dynamic programming; searching for a rerouted path that maximizes token isolation can then be performed in [symbol] (n³) time.

A possible extension of the rerouting subroutine that we have developed, but whose performance we have not quantified, is to search for paths that might not necessarily preserve the minimum total displacement distance or minimum number of displacement operations. The distance-increasing rerouting subroutine trades off an increase in displacement operations for a decrease in transfer operations. This subroutine runs in [symbol] (n⁷) time on uniformly-weighted grids. We note that the aro algorithm would still work as expected if we were to replace the distance-preserving rerouting with the distance-increasing rerouting subroutine.

### Combining Rerouting and Ordering

In one example embodiment, algorithm 2 below, the algorithm solves atom reconfiguration problems in seven steps, five of which are imported from the assignment algorithm (algorithm 1 above).

```
Algorithm 2. The ARO algorithm.
Require: A static trap array A, represented as a positive
  edge-weighted graph G = (V, E) with Σ_{eϵE(G)} w(e) = O(n^{c}) for
  some positive integer c; an initial configuration of atoms C₀,
  represented as a set of source vertices S ⊆ V (G); and a target
  configuration of atoms C_{T}, represented as a set of target vertices
  T ⊆ V (G).
1. Compute the distance and a shortest path between all pairs of
  vertices of S and T by solving the APSP problem [O(n³) and
  O(n²) on uniformly weighted grid graphs].
2. Compute a distance-minimizing path system, matching every
  vertex in T to a distinct vertex in S and forming a shortest path
  between them by solving the assignment problem [O(n³)].
3. (optional) Using the isolation subroutine, modify the path system
  to (locally) isolate tokens that do not need to be displaced
  [O(n⁵)].
4. Using the ordering subroutine, order the paths in the path system,
  which breaks cycles if they exist [O(n^{c+6}m) and O(n⁸) on
  uniformly weighted grid graphs].
5. Using the obstruction solver subroutine, find a sequence of
  unobstructed moves [O(n²)].
6. (optional) Using the batching subroutine, batch moves to perform
  control operations on multiple atoms in parallel [O(n³)].
```

In the first three steps, similarly to the assignment algorithm, the assignment subroutine computes a valid distance-minimizing path system by solving the all-pairs shortest path (APSP) problem and the assignment problem, and optionally isolates a maximal subset of tokens located on doubly-labeled vertices by using the isolation subroutine. Instead of directly computing the sequence of moves to execute as in the assignment algorithm, the aro algorithm seeks to further update the path system. In the fourth step, the rerouting subroutine seeks to reroute each path in the path system in an attempt to reduce the number of displaced atoms. In the fifth step, the ordering subroutine constructs an ordered path system that admits an ordering of its paths, guaranteeing that each atom moves at most once. In the sixth step, similarly to the assignment algorithm, the baseline obstruction solver computes a sequence of unobstructed moves associated with the path system; because the paths are ordered, the move associated with each path is unobstructed, and solving the obstruction problem is trivial. In the seventh (optional) step, the batching subroutine combines some of the moves to simultaneously displace multiple atoms in parallel.

One implementation of the aro algorithm is designed to work with general edge-weighted graphs and runs in time [symbol] (n⁸) on uniformly-weighted grid graphs.

A novel process of benchmarking reconfiguration processes, including a process of providing a suitable and intuitive computerized user interface, is presented at sections IV to VI of the appended manuscript entitled “Efficient algorithms to solve atom reconfiguration problems. I. The redistribution-reconfiguration (red-rec) algorithm”.

Such a process can begin by simulating a reconfiguration process entirely on a computer, for different values of variable parameters, and storing the results of the simulations, including in particular whether the simulation has a high success probability, a low success probability, or an intermediary success probability for a given combination of values of variable parameters, in the memory of the computer. These results can then be graphically represented such as presented FIGS. 3 and 4 of the appended manuscript, which can include representing domains of high success probability in a first color or tone, domains of low success probability in a second color or tone, and domains of an intermediary success probability in yet a third color or tone. This can allow easily comparing one reconfiguration process to another and determining which one is more appropriate for the circumstances. The simulations can represent performance in a manner to closely represent experimental outcome. In some embodiments, this can help a user to determine what the limitations of a given reconfiguration process are.

The simulations can be performed on computer and involve solving a given reconfiguration problem including executing a protocol in the computer to simulate particle loss and/or noise, such as randomly sample atoms being lost, determine whether the process was successful or not, compute mean success probability for a given problem, and repeat the process for many different problems.

As seen in the examples presented, the computer-implemented process can present additional information on a display screen of a user interface, such as how many displacement operations are required to reach success or failure, number of displacement operations, number of transfer operations, number of atom moves, number of atom losses, etc.

In a particular embodiment, shaded regions can be used to represent what a system would need to enter those regions.

Using such a process, it can be easy to compare different approaches—i.e. perform process on two scenarios and compare. The process can be applied to any suitable reconfiguration algorithm. For instance In one embodiment, this benchmarking process can be applied to the AO reconfiguration process, the AR reconfiguration process, and/or to the ARO reconfiguration processes.

It will be noted that to be able to compare number of moves or mean success probability, one may needs a representative value of the loss parameter. This can be determined by performing experiments on the system, e.g. by measuring the loss parameter directly or indirectly (e.g. measure pressure).

Benchmarking in the absence of loss can represents a baseline success probability. In the absence of a sufficient number of traps, the process may always fail. Using the baseline success probability, a reconfiguration process can be compared to such a baseline success probability rather than being compared to another reconfiguration process.

In the embodiments presented above, or other embodiments, a thresholding process can be used to reduce mean wait time between the preparation of two successful configurations. This process can include comparing the number of particles contained in the particle traps to a threshold number of particles, and proceeding to the reconfiguration of the particles only if the number of particles is deemed to be sufficient (e.g. above the threshold number). In the event where the number of particles is deemed insufficient (e.g. below the threshold number), the initial configuration of particles in the particle traps can be reset by re-doing the loading step, until the threshold number is met, at which stage the process can proceed to reconfiguring the particles in the particle traps. In this manner, the mean wait time can be reduced by rejecting initial configurations containing less atoms than a given threshold.

The threshold can correspond to a number of target particle traps. Alternately, a threshold greater than a number of target particle traps can be set in some embodiments. Section VII of the attached manuscript provides a greater amount of detail as to how such a threshold can be set. The thresholding process can be applied independently of the nature of the reconfiguration process being used.

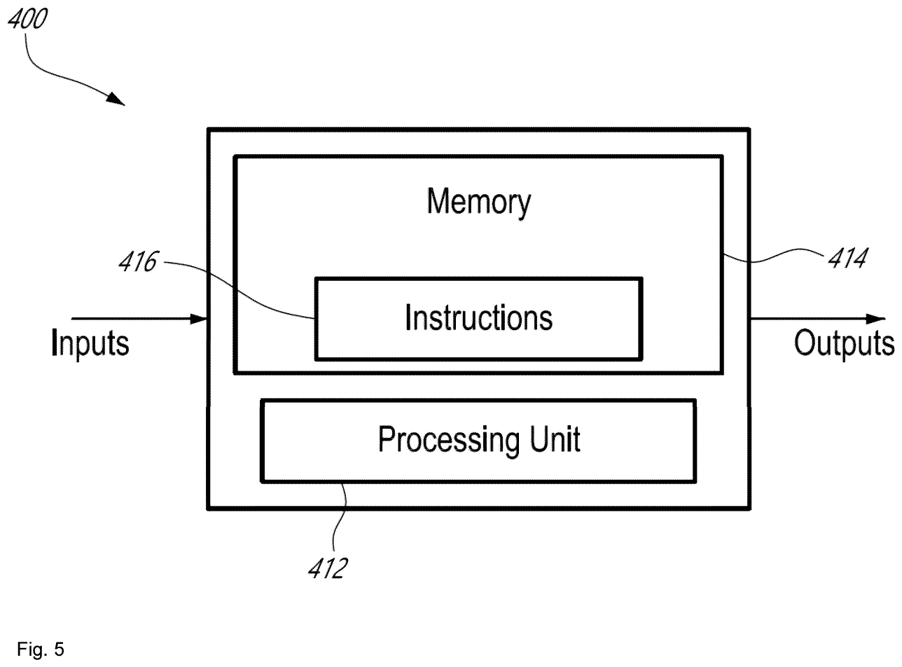

Referring to FIG. 5, it will be understood that the expression “computer” 400 as used herein is not to be interpreted in a limiting manner. It is rather used in a broad sense to generally refer to the combination of some form of one or more processing units 412 and some form of memory system 414 accessible by the processing unit(s). The memory system can be of the non-transitory type. The use of the expression “computer” in its singular form as used herein includes within its scope the combination of a two or more computers working collaboratively to perform a given function. Moreover, the expression “computer” as used herein includes within its scope the use of partial capabilities of a given processing unit.

A processing unit can be embodied in the form of a general-purpose micro-processor or microcontroller, a digital signal processing (DSP) processor, an integrated circuit, a field programmable gate array (FPGA), a reconfigurable processor, and a programmable read-only memory (PROM, to name a few examples.

The memory system can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM)to name a few examples.

A computer can have one or more input/output (I/O) interface to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions. Different elements of a computer, such as processor and/or memory, can be local, or in part or in whole remote and/or distributed and/or virtual.

The methods and systems of the present disclosure may be implemented in a high level procedural or object oriented programming or scripting language, or a combination thereof, to communicate with or assist in the operation of a computer. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 412 of the computing device 400, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments. The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

As can be understood, the examples described above and illustrated are intended to be exemplary only. From point of view of a process of solving a reconfiguration problem, , indistinguishable particles can be represented as “tokens”. The nature of the indistinguishable particles can vary depending on the embodiment, and can be one or more of atoms, ions, charges and exotic quasi-particles for instance. A particle trap can be embodied as a combination of hardware and software elements which collaborate to generate a trapping potential for a particle, i.e. which can localize a particle in space. Optical traps (e.g. atoms trapped tightly-focussed laser beams) and electromagnetic traps (e.g. charged ions trapped in electromagnetic fields generated by electrodes) are examples of particle traps. In some examples presented above, the target configuration is centered-compact, but this is not necessarily the case for all embodiments and different embodiments can have target configurations of different nature. In some examples presented above, the target configuration has a square lattice with a rectangular boundary, but this is not necessarily the case for all embodiments and different embodiments can have other graph configurations. Moreover, these algorithms and the formal results that underpin them can support applications in other contexts, such as robot motion planning, warehouse resource allocation, and game design. The scope is indicated by the appended claims.

What is claimed is:

1. A computer-implemented method of solving a reconfiguration problem, the method comprising:
providing, in a non-transitory memory of the computer, a definition of the reconfiguration problem, the definition including an initial configuration of token source locations on a graph and a target configuration of token target locations on the graph; and
a processor of the computer, based on instructions stored in the non-transitory memory:
solving an all-pairs shortest path (APSP) problem on the definition of the reconfiguration problem, said solving the APSP problem including computing a distance between each token source location and each token target location;
solving an assignment problem on the computed distances, said solving the assignment problem yielding a path system having a set of shortest paths;
performing a cycle breaking function on the path system, the cycle-breaking function breaking all cycles in the path system; and
ordering order the cycle free path system.

2. The method of claim 1 wherein said solving the APSP problem includes executing a function based on a Floyd-Warshall algorithm on the definition of the reconfiguration problem.

3. The method of claim 1 wherein said solving the APSP problem includes executing a function based on a Dijkstra algorithm on the definition of the reconfiguration problem.

4. The method of claim 1 wherein said solving the assignment problem includes executing a function based on a global method of solving an assignment problem.

5. The method of claim 4 wherein said solving the assignment problem includes executing a function based on a Hungarian algorithm.

6. The method of claim 1 wherein said solving the assignment problem includes executing a function based on a local method of solving an assignment problem.

7. The method of claim 1 wherein said performing the cycle breaking function includes computing a merged path system from the path system; computing an unwrapped path system from the merged path system, and detecting and breaking cycles in the unwrapped path system.

8. The method of claim 1 wherein performing a cycle breaking function includes: while the graph (G) induced on unwrapped path system P (G[P]) has a cycle C: go over edges (e) of the cycle C one by one and construct a graph G′=G−e, compute a new path system P′ in the graph G′, until the new path system P′ is valid and distance minimizing.

9. The method of claim 1 wherein said ordering the cycle free path system includes constructing a direct acyclic graph (DAG).

10. The method of claim 1 wherein said definition of the reconfiguration problem includes a static trap array, A, represented as a positive uniformly-weighted grid graph G=(V, E) with |V(G)|=n, |E(G)|=m= [symbol] (n), and Σ_{e∈E(G)} w(e)= [symbol] (n), i.e., c=1; an initial configuration of atoms, C₀, represented as a set of source vertices, S⊆V(G); and a target configuration of atoms, C_{T}, represented as a set of target vertices, T⊆V(G).

11. The method of claim 10 wherein said assignment function includes: computing the distance and a shortest path between all vertices of S and T by solving the all-pairs shortest path (APSP) problem ( [symbol] (n²) on uniformly-weighted grids, [symbol] (n³) on arbitrary weighted graphs); computing a distance-minimizing path system, drawing a shortest path between each vertex of T with a vertex of S, by solving the assignment problem ( [symbol] (n³)); and finding a sequence of unobstructed moves using the baseline obstruction solver ( [symbol] (n²)).

12. The method of claim 11 wherein said assignment function further includes, subsequently to said computing a distance-minimizing path system and prior to said finding a sequence of unobstructed moves, modifying the path system to isolate tokens that do not need to be displaced using the isolation subroutine ( [symbol] (n⁵)).

13. The method of claim 11 wherein said assignment function further includes, subsequently said finding a sequence of unobstructed moves, batching the moves to perform control operations on multiple atoms in parallel using the batching subroutine ( [symbol] (n³)).

14. The method of claim 12 wherein said cycle breaking function is performed subsequently to said computing a distance-minimizing path system and prior to said finding a sequence of unobstructed moves, ( [symbol] (n⁸)).

15. The method of claim 10 wherein the path system is defined on said uniformly-weighted grid graph G , and said breaking the cycles includes merging the path system ( [symbol] (n^{c+4}m²)= [symbol] (n⁷)), unwrapping the path system ( [symbol] (n²m)= [symbol] (n³)), detecting and breaking the cycles in path system ( [symbol] (n^{c+6}m)= [symbol] (n⁸)), and ordering the path system ( [symbol] (n³).

16. The method of claim 11 further comprising, subsequently to said computing a distance-minimizing path system and prior to said finding a sequence of unobstructed moves, rerouting the paths in the path system to locally minimize collisions in the path system using a rerouting subroutine ( [symbol] (n³)).

17. The method of claim 1 further comprising, prior to said performing a cycle breaking function, performing a rerouting function, the rerouting function reducing a number of token displacements to reach the target configuration without increasing a total displacement distance.

18. The method of claim 1 further comprising measuring the presence or absence of particles in corresponding ones of a plurality of particle traps, and defining the initial configuration including associating a presence of particles in said particle traps to said tokens at source locations.

19. The method of claim 1 further comprising reconfiguring the particles in the particle traps including executing the cycle free path system.

20. A computer-implemented method of solving a reconfiguration problem, the method comprising:
providing, in a non-transitory memory of the computer, a definition of the reconfiguration problem, the definition including an initial configuration of token source locations on a graph and a target configuration of token target locations on the graph; and
a processor of the computer, based on instructions stored in the non-transitory memory:
solving an all-pairs shortest path (APSP) problem on the definition of the reconfiguration problem, said solving the APSP problem including computing a distance between each token source location and each token target location;
solving an assignment problem on the computed distances, said solving the assignment problem yielding a path system having a set of shortest paths; and
performing a rerouting function, the rerouting function reducing a number of token displacements to reach the target configuration without increasing a total displacement distance.

21. The method of claim 20 further comprising measuring the presence or absence of particles in corresponding ones of a plurality of particle traps, and defining the initial configuration including associating a presence of particles in said particle traps to said tokens at source locations.

22. The method of claim 20 further comprising reconfiguring the particles in the particle traps including executing the cycle free path system.
